(19) United States
(12) Patent Application Publication
(10) Pub. No.: US 2009/0251146 A1
(43) Pub. Date: Oct. 8, 2009

(54) Detection of Porphyry Copper Deposit Using Natural Electromagnetic Fields

(75) Inventors: Edward B. Morrison, Stouffville (CA); Bob Bak Lo, Markham (CA)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Geotech Airborne Limited, St. Michael (BB)

(21) Appl. No.: 12/062,795

(22) Filed: Apr. 4, 2008

(51) Int. Cl. G01V 3/16

(52) U.S. Cl. 324/330

(57) ABSTRACT

A method for identifying a possible porphyry copper deposit which includes flying an airborne sensor over a survey area measuring natural electromagnetic fields in the survey area, and then determining, in dependence on the measured natural electromagnetic fields, if one or more sub-areas in the survey area have a resistivity pattern that corresponds to a predetermined resistivity signature for a porphyry copper deposit. The predetermined resistivity signature includes a higher resistivity inner region at least partially surrounded by a lower resistivity outer region

### BACKGROUND OF THE INVENTION

Example embodiments are described below that relate to a system and method for detecting specific types of geological deposits using geological survey data derived from natural electromagnetic field data.

The use of audio frequency magnetic (“AFMAG”) geological survey systems that use airborne sensors to measure natural electromagnetic fields generated from events such as lightening strikes has been described in documents such as U.S. Pat. No. 3,149,278 (Cartier et al.) and U.S. Pat. No. 6,876,202 (Morrison et al.).

Porphyry copper deposits are large, low grade copper-gold mineral deposits that have been difficult to detect using airborne survey techniques.

### BRIEF DESCRIPTION OF THE DRAWINGS

A description of example embodiments is provided below with reference to the following drawings in which:

FIGS. 1a and 1b are generalized cross-sectional views of an undisturbed, whole, porphyry system showing alteration zones (FIG. 1a) and mineralization zones (FIG. 1b);

FIG. 2 is graph showing inphase and quadrature of the Tipper Tx component at various frequencies;

FIG. 3 is a block diagram illustrating an AFMAG survey device according to an example embodiment; and

FIG. 4 is a graphical representation of the resistivity signature of a porphyry copper deposit; and

FIG. 5 is a contour map showing an AFMAG data example from a survey of a porphyry copper deposit.

### SUMMARY

According to one example embodiment is a method for identifying a possible porphyry copper deposit which includes flying an airborne sensor over a survey area measuring natural electromagnetic fields in the survey area, and then determining, in dependence on the measured natural electromagnetic fields, if one or more sub-areas in the survey area have a resistivity pattern that corresponds to a predetermined resistivity signature for a porphyry copper deposit. The predetermined resistivity signature includes a higher resistivity inner region at least partially surrounded by a lower resistivity outer region.

According to another example embodiment is a method for identifying a possible porphyry copper deposit which includes: (a) conducting an airborne audio frequency magnetic (“AFMAG”) geophysical survey of a survey area measuring low frequency natural electromagnetic fields in the survey area; (b) calculating a plurality of tilt angles of the electromagnetic waves of the low frequency natural electromagnetic fields; and (c) determining in dependence on the calculated tilt angles if one or more sub-areas in the survey area have a resistivity pattern that corresponds to a predetermined resistivity signature for a porphyry copper deposit, the predetermined resistivity signature including a higher resistivity inner region at least partially surrounded by a lower resistivity outer region.

### DESCRIPTION

Example embodiments described below include an airborne audio frequency magnetic (“AFMAG”) geophysical survey system and method for identifying potential porphyry copper deposits, which have traditionally been difficult to detect through airborne electromagnetic geophysical surveys.

To facilitate a better understanding of example embodiments of the invention, a brief description of porphyry copper deposits will first be provided as follows.

Porphyry copper deposits (also referred to herein as porphyries) are a recognized type of large, low grade copper-gold mineral deposit. They are described as disseminated copper mineralization in or adjacent to quartz monozonitic igneous porphyritic rock and with the broad and general economic and engineering sense of large low-grade epigenetic hypogene copper deposits that can be mined by bulk mining methods. Important associated minerals include copper-molybdenum with minor tungsten and silver deposited in central zones interior to fringing copper-zinc-lead-silver with minor manganese, arsenic, gold, antimony and selenium.

Porphyry copper deposits originate with the intrusion of porphyritic rock. Hydrothermal fluid circulation caused by hot magma modifies the minerals in the rocks they pass through a process called hydrothermal alteration. The metallic minerals that the intrusion and the host rocks contain can be concentrated and precipitated at various zones. The hydrothermal alteration accompanying these deposits causes changes in the physical property of the rocks.

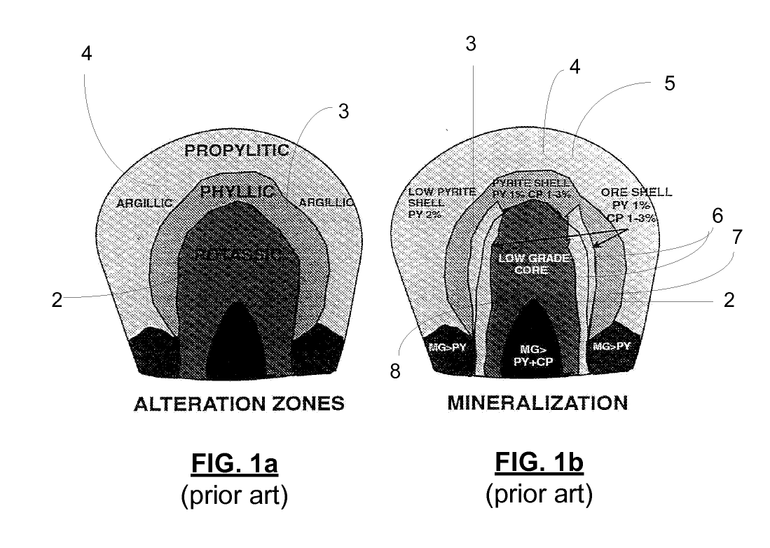

With reference FIGS. 1a and 1b, Lowel, J. D., and Guilbert, J. M., 1970, Lateral and Vertical Alteration Mineralization Zoning in Porphyry Ore Deposits: Economic Geology, vol. 65. generalizes the alteration around and within the edges of a porphyry deposit into a potassic zone 2, a phyllic zone 3, and propylitic and argillic zones 4 (FIG. 1a). The mineralization in these alteration packages is different (FIG. 1b), the propylitic and argillic zones 4 generally comprise a low pyrite shell 5 (PY2%). An ore shell 6 (PY1%, CP1-3%) exists at an inner portion of the phyllic zone 3 and an outer portion of the potassic zone 2, with the remainder of the potassic zone 2 generally comprising a low grade core 8, and remainder of the phyllic zone 3 generally comprising a pyrite shell 7 (PY1%, CP1-3%). FIGS. 1a and 1b are sectional depictions of the system. In 3D, the system is symmetrical about an axis of rotation.

Hydrothermal alteration and sulphide deposition causes change in the resistivity of the rock. Pervasive clay minerals associated with argillic-propylitic alteration zones generate low resistivities in the 10 to 30 ohm-metre range. The low resistivity anomalies are comparable in size to the original geothermal system which are typically 10 to 30 square kilometers. The low grade core, with lower sulphide content, would have a higher resistivity than the host rock.

Once the porphyry system has been emplaced, erosional effects take place. Depending on the level of erosion, different alteration packages are exposed. A level or plan cut to the level below the low grade core will yield an alteration pattern in plan that consists of annuli of different alteration. Faulting, deformation, and differential erosion complicate the pattern. As well, younger cover rocks or sediments can also geophysically mask the signature of the porphyry.

A brief description of porphyry copper deposits having been provided, example embodiments of an airborne AFMAG device that can be employed for detecting such deposits will now be described.

With the exception of airborne AFMAG, typical airborne electromagnetic (“EM”) utilize artificial and controlled electromagnetic fields produced by transmitter coils. These artificial fields are not homogeneous but decay inversely proportional to the cube of distance from the transmitter. This factor limits investigation depth to approximately 400 to 500 metres for the advanced airborne systems now in use. Smaller but shallow conductors, because they are closer to the transmitter, can mask large conductors at greater depth. Conventional airborne survey systems that use artificial fields must be flown at low altitudes to offset this common juxtaposition of conductive patterns.

AFMAG technology uses natural fields over a wide frequency range, as opposed to artificial EM survey systems. These natural fields are primarily homogeneous and their intensity does not depend on distance from the “transmitter” (i.e. the naturally occurring EM source). For each frequency, effective penetration depth therefore depends on the resistivity (or conductivity) structure of the Earth only. For example, at 100 Hz, a large conductor would be visible up to 300 m beneath 100 Ohm-m sediments. For lower frequencies or for rocks with higher resistivity this exploration depth will increase.

Also, for the natural (and primarily homogeneous) EM sources used in AFMAG, small shallow conductors do not mask the responses of large, deeper conductors. This is mostly due to the slow decay of the primary field with depth. In this manner, the near surface conductors are not excited by a much stronger primary field as compared to the deeper conductors.

The natural EM field is normally horizontally polarized. Subsurface lateral variations of conductivity generate a vertical component, which is linearly related to the horizontal field. Although the fields look like random signals, they may be treated as the sum of sinusoids. At each frequency the field can be expressed as a complex number with magnitude and an argument equal to the amplitude and phase of the sinusoid. The relation between the field components can then be expressed by a linear complex equation with two complex coefficients at any one frequency. As known in the art, these coefficients are dependent upon the subsurface and not upon the horizontal field present at any particular time.

Hz(f)=Tx(f)Hx(f)+Ty(f)Hy(f), Eq. (1)
Where
Hx(f), Hy(f) and Hz(f) are x, y and z components of the field as a function of frequency (f),
Tx(f) and Ty(f) are the “tipper” coefficients.

In the case of a horizontally homogeneous environment, Tx and Ty are equal to zero because Hz=0. They show certain anomalies only by the presence of changes in subsurface conductivity in the horizontal direction. The real parts of the tipper coefficients correspond to tangents of tilt angles measured with a controlled source. The complex tensor [Tx, Ty] known as the “tipper” defines the vertical response to horizontal fields in the x and y directions respectively.

Tx and Ty are two unknown coefficients in one equation, and one therefore must combine two or more sets of measurements to solve them. To reduce effects of noise, multiple sets of measurements can be made, and the coefficients, which minimize the squared error in predicting the measured Z from X and Y, can be found. This leads to the following formulas for estimating the coefficients:

Tx=([HzHx*][HyHy*]−[HzHy*][HyHx*])/([HxHx*][HyHy*]−[HxHy*][HyHx*]) Eq. (2)

and

Ty=([HzHy*][HxHx*]−[HzHx*][HxHy*])/([HxHx*][HyHy*]−[HxHy*][HyHx*]) Eq. (3)

### Where

[HxHy*] (for example) denotes a sum of the product of Hx with the complex conjugate of Hy.

In practical processing algorithms, all numbers Hx, Hy and Hz can be obtained by applying the same digital band-pass filters to three incoming parallel data signals. FFT (Fast Fourier Transform) algorithms are also applicable. All sums like [HxHy*] can be calculated on the basis of a discrete time interval in the range from 0.1 to 1 sec or on a sliding time base.

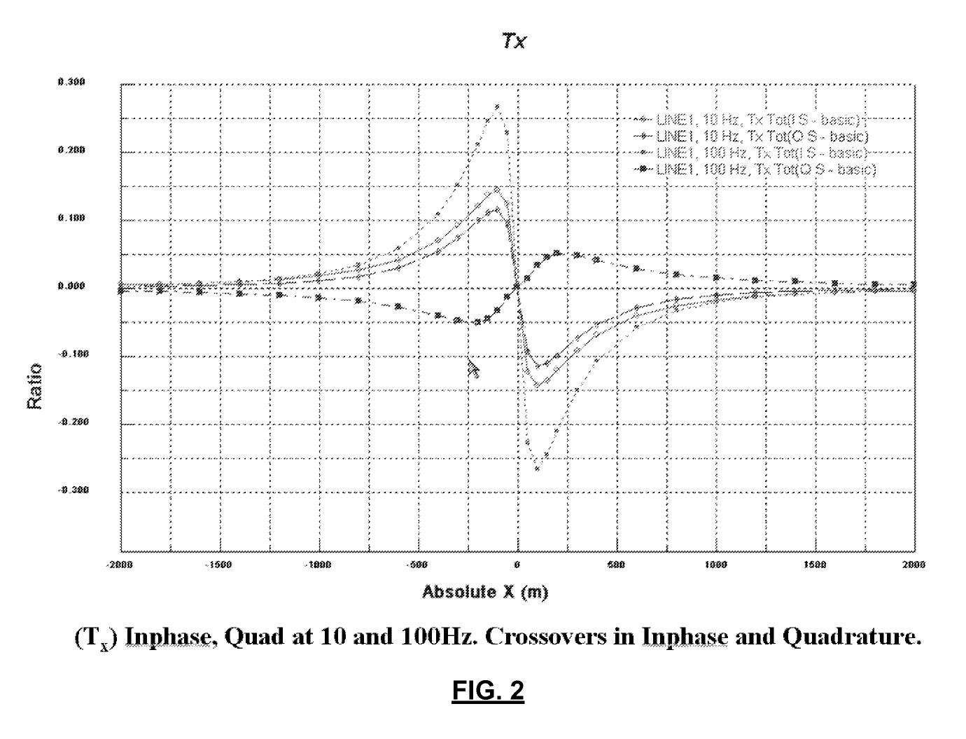

The two coefficients of the Tipper, Tx and Ty, are then calculated via the Tipper transformation equations (2) and (3) and the useable frequencies extracted from the time series. The sense of the EM data, in a local coordinate system which is relative to the airborne EM receiver, has to be reversed for survey lines in reciprocal directions. The transformed data is in the form of Tipper tilt angles where a vertical conductor is detected as a cross-over. The tilt angles are then phase rotated by 90 degrees to transform the cross-overs into peaks. This process creates a local data maximum, positioned over the conductive anomaly from the cross-overs. For the quadrature data, depending on the resistivity contrast, the cross-over can change sense. This means that the 90 degree phase rotation will produce both peaks and minimums over the vertical conductors. For this reason, the quadrature data are presented as tilt angles only. By way of example, FIG. 2 is a graphical representation of a basic model response, and in particular, the inphase and quadrature of the Tx component at various frequencies under the following parameters: (a) Strike is in the y (North) directions and the flight is in the x(east) direction at a sensor height of 30 m above ground; Strike Length: 1 km; Depth Extent: 1 Km; Conductance: 100 S; Depth to Top: 10 m; Thin-overbyrden (10 m), Resistive basement (1000 hm-m).

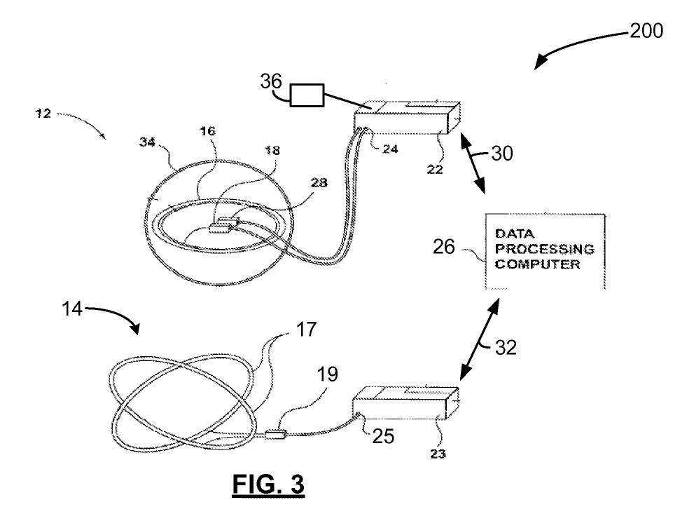

FIG. 3 illustrates an AFMAG survey system 200 according to an example embodiment. The AFMAG system 200 includes an air assembly 12 and a ground assembly 14. The air assembly 12 is mounted on or in an aircraft or towed by an aircraft over a survey area and includes at least one electromagnetic sensor 16 and low noise amplifier 18. In an example embodiment the electromagnetic sensor 16 is a receiver coil configured to have a vertical dipole orientation during flight in order to provide electromagnetic field measurements in the Z axis. The air assembly 12 is connected to signal processing equipment that is generally disposed inside the aircraft such as a computer 22 that includes an analog to digital converter device (ADC) 24 connected to receive the output of the low noise amplifier 18. The on-aircraft computer 22 is equipped with one or more storage elements that can include RAM, flash memory, a hard drive, or other types of electronic storage, and may be configured to perform data processing functions on signals received from sensor 16.

In an example embodiment, the air assembly 12 also includes a spatial attitude detection device 28 to compensate for the roll, pitch or yaw of air assembly 12 and particularly sensor 16 in flight that can cause anomalies in measurement of the tilt angles produced by the electromagnetic fields by electromagnetic sensor 16. The spatial attitude detection device 28 includes inclinometer devices for measuring the roll, pitch and yaw of the air assembly 12 and particularly sensor 16 during flight at any given moment. In addition for yaw measurements, the spatial attitude detection device 28 may comprise a device for tracking the flight path such as a compass utilizing direction magnetic field vector. In example embodiments, the air assembly 12 or host aircraft can include a Global Positioning System (“GPS”) device such that data obtained from sensor 16 and spatial attitude detection device 28 can be correlated with a geographical position GPS time signal and ultimately used either at computer 22 or a remote data processing computer 26 to correct the measurements of the electromagnetic field tilt angles to reflect the movements of the air assembly 12 and particularly sensor 16, and correlate the electromagnetic field data obtained from sensor 16 with the spatial attitude data of air assembly 12. This allows the creation of survey data that can be adjusted based on variations of the spatial attitude of the sensor 16 during flight.

In an example embodiment, the airborne equipment also includes a geographic relief measurement device 36 connected to the airborne computer 22 in order to allow compensation for geographical relief that could otherwise distort horizontal magnetic fields by producing false anomalies of tilt angles even where there are very homogeneous rocks beneath the ground surface. Geographic relief measurement device 36 collects data for post flight (or in some cases real-time) calculations of the tilt angles of geographical relief in the survey area. In one example embodiment, the geographic relief measurement device 36 includes a first altimeter device that provides data regarding absolute altitude of the airborne sensor 16 above a fixed reference (for example sea level) and a second altimeter device that providing data regarding the relative altitude of the of the airborne sensor 16 above the actual survey terrain. Comparing the relative altitude data and absolute altitude data in the local co-ordinate system of the survey area allows an evaluation of the geographic relief of the survey area that can be used to calculate the tilt angles of the survey area geographic relief.

The ground assembly 14 is configured to be placed on a stationary base point, and includes at least a pair of electromagnetic sensors 17 connected through a low noise amplifier 19 to a ground assembly computer 23. In an example embodiment the electromagnetic sensors 17 are receiver coils configured to provide electromagnetic field measurements in the X and Y axes. The computer 23 includes an analog to digital converter device (ADC) 25 connected to receive the output of the low noise amplifier 19, and is equipped with one or more storage elements that can include RAM, flash memory, a hard drive, or other types of electronic storage, and may be configured to perform data processing functions on signals received from sensors 17. The ground assembly can also include a GPS receiver so that the X and Y axis data received from sensors 17 can be time stamped with a GPS clock time for correlation with the Z axis data that is recorded by airborne computer 22. (Z-axis being the vertical axis and X and Y being orthogonal horizontal axis.)

In an example embodiment, the data collected by airborne computer 22 and the data collected by the ground computer 23 is ultimately transferred over respective communication links 30, 32 (which may be wired or wireless links or may include physical transfer of a memory medium) to a data processing computer 26 at which the electromagnetic field data obtained from sensors 16 and 17, the attitude data from spatial attitude detection device 28, data from geographic relief measurement device 36, and the GPS data from GPS sensors associated with each of the air assembly 12 and ground assembly 14 can all be processed to determine the tipper attributes for the survey sight.

With equations (2) and (3) set out above, in weak electromagnetic field conditions where the level of the signal is comparable with noise level, the bias in estimated values of Tx and Ty caused by noise in the horizontal signals become substantial. This bias can be mitigated by the use of the remote reference signals from two additional X and Y coils in the ground assembly in addition to main X and Y coils 17, such that:

Tx=([HzRx*][HyRy*]−[HzRy*][HyRx*])/([HxRx*][HyRy*]−[HxRy*][HyRx*]) Eq. (4)

and

Ty=([HzRy*][HxRx*]−[HzRx*][HxRy*])/([HxRx*][HyRy*]−[HxRy*][HyRx*]) Eq. (5)

### Where

Rx is the reference field x component,
Ry is the reference field y component.

Using the data collected from the air and ground assemblies and the above equations, the tipper coefficients or tilt angles for the survey sight can be determined by data processing computer 26. Although the X and Y sensors 17 of device 200 are shown as being part of a ground assembly, in at least some example embodiments, the X and Y sensors 17 are integrated into the air assembly 12. Example embodiments of geological survey devices such as device 200 that can be used to provide tipper readings for a survey sight are described in greater detail in U.S. Pat. No. 6,876,202 to Morrison et al.

A brief description of porphyry copper deposits having been provided above, as well as a description of example embodiments of an airborne AFMAG device, a method for detecting porphyry copper deposits using an airborne AFMAG device will now be described.

According to an example embodiment, an airborne AFMAG geophysical survey is conducted of an area of interest using an AFMAG survey device such as device 200 described above. In one example embodiment, a survey is conducted on an area that is between 10 km² and 20,000 km², however in other example embodiments the size of the survey area can be smaller or greater.

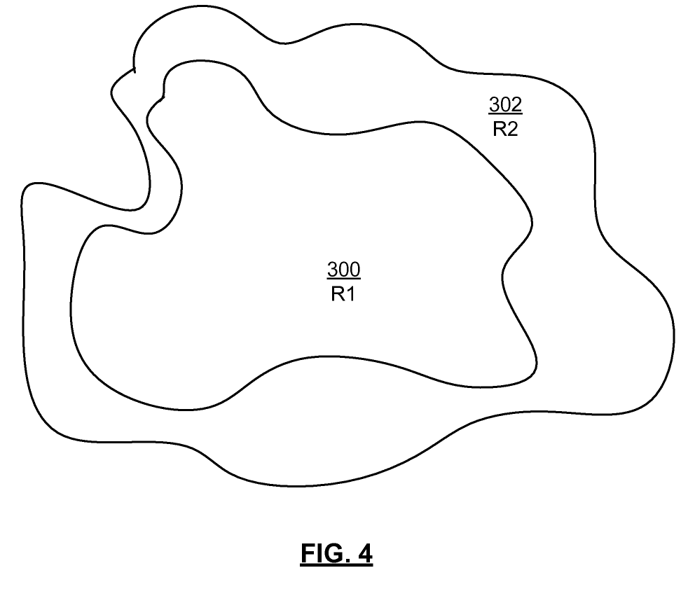

The collected information is used to determine tipper or the tilt angles for the surveyed region, which is representative of resistivity information for the survey area. The survey information (one or both of the tipper and tilt angles) that is representative of the resistivity information of the survey area is then analyzed, for example with the aid of data processing computer 26, to determine if the survey area includes any regions that have a resistivity pattern that matches with a predetermined resistivity signature (as represented by the tipper or tilt angle data) that is indicative of a porphyry copper deposit. In one example embodiment, as illustrated in FIG. 4, the predetermined resistivity signature includes a conductive ring-like structure 302 that extends generally around a more resistive core 300. The higher conductivity (1/R2) of the ring 302 is due to the alteration discussed above, plus disseminated sulphide mineralization. The resistive core 300 gets its higher resistivity (R1) from the higher resistivity of the monzonitic intrusion that forms it, which generally is much lower in sulphides than the alterated and mineralized zones forming the outer ring 302. The ring 302 corresponds generally to the propylitic and argillic zones 4 of FIG. 1a, and the resistive core 300 corresponds generally to the phyllic and potassic zones 2, 3 of FIG. 1a.

In example embodiments, the resistivity signature is selected to focus on porphyry copper deposits where the core area is approximately 2 to 8 km² in size and the total area of the inner core 300 and the outer ring 302 together is approximately 10 to 30 km². The difference in magnitude of the resistivity between the outer ring 302 and the inner core 300 is relatively low by geological standards, with the resistivity R1 of the inner core 300 generally being only one or two orders of magnitude (i.e 10 to 100 times) greater than the resistivity R2 of the surrounding region 302. Thus, in one example embodiment the resistivity signature for a porphyry copper deposit is a body having an inner core area 300 that is approximately 2 to 8 km² in area and which is generally surrounded by an outer ring 302 having a resistivity R2 that is approximately one to two orders of magnitude lower than the resistivity R1 of the core, and where the outer ring 302 and inner core area 300 together cover an approximate area of 10 to 30 km². In other example embodiments, the target range in size may be modified to have upper and lower limits that are each greater or smaller than 10 to 30 km², and furthermore, in some example embodiments, the difference in the resistivity between the inner and outer regions 300, 302 may also be targeted outside of the range stated above, so long as the change in resistivity between the resistivity of the inner and outer regions is known to be indicative of the type of porphyry copper deposit that is being sought.

It will be appreciated that due to the manner in which porphyry copper deposits are formed, in at least some deposits, the ring 302 may extend only intermittently around the entire core 300 in that it will start and then stop at various locations and the thickness of the ring 302 around the core may vary substantially. Accordingly, the outer ring 302 may not completely surround the inner core region 300.

Regions within the survey area that are identified as having resistivity pattern matching the predetermined porphyry copper deposit signature are identified as regions that have a high probability of being a porphyry copper deposit. In at least some example embodiments, such regions are then subjected to physical sampling to confirm the results of the AFMAG survey.

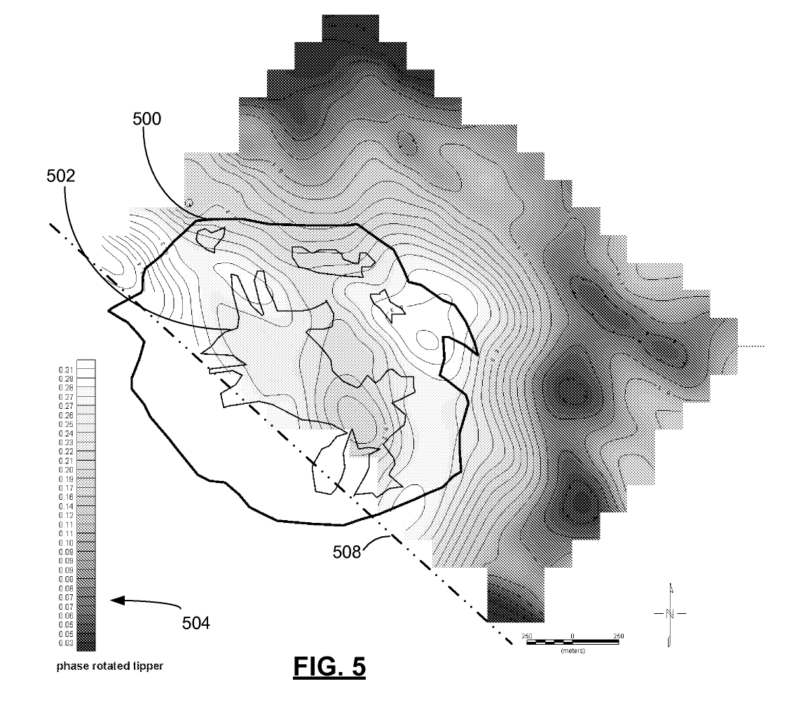

FIG. 5 illustrates the results of a test survey using airborne AFMAG surveying techniques for detecting a porphyry copper deposit. FIG. 5 is a contour map of the survey area showing the in-line direction X-component tilt angle at f=109 hz, phase rotated. The AFMAG survey that resulted in the data of FIG. 5 was conducted using the equipment and methods similar to that described above. In particular, an airborne sensor for measuring the vertical EM field in the air was flown along flight lines in northwest-southeast and northeast-southwest directions, at a spacing of 500 meters for both sets of lines, with a total survey coverage of approximately 225 line kilometers. The airborne sensor was towed at a ground speed of approximately 35 knots, and suspended from a 90 m cable from an aircraft flying at an average aircraft terrain clearance of a approximately 150 meters. Horizontal EM fields were measured using a pair of perpendicular stationary base station coils which were set up in the same direction as the flight lines. The airborne data was merged with base station records using GPS time to synchronize the records, and the data then filtered to remove 60 Hz and related harmonic noise. Additionally, the airborne EM data was corrected for the airborne sensor coil being off-horizontal by attitude and GPS measurements from the airborne sensor coil.

The components of the Tipper were then calculated for the survey area using the Tipper transformation and the usable frequencies extracted from the time series. The sense of the EM data, in a local coordinate system which is relative to the airborne sensor, is reversed for survey lines in reciprocal directions to account for the fact the sensor is flown back and forth in parallel lines. Tipper tilt angles were obtained from the transformed data. As a vertical conductor will be detected as a cross-over, the tilt angles were phase rotated by 90 degrees to transform the cross-overs into peaks. For the quadrature data, depending on the resistivity contrast, the cross-over can change sense. This means that the 90 degree phase rotation will produce both peaks and minimums over the vertical conductors. For this reason, the quadrature data is not presented.

In the survey area represented by FIG. 5, a known porphyry deposit is shown generally outlined by the line indicated by reference 500. Power line noise rendered the data from the area south-west of line 508 unusable, and so the data shown is limited to a north-east portion of the porphyry deposit. The line 500 surrounds alteration and mineralization zones that corresponds generally to an ore shell (similar for example to ore shell 6 of FIG. 1b), with the inner line 502 surrounding an area that corresponds generally to a barren core (similar to low grade core 8 of FIG. 1b), such that the area between lines 500 and 502 generally indicates a porphyry copper ore shell. The contour lines on the map of FIG. 5 and the grey scale represent the X-component tilt angle at f=109 hz, phase rotated for the survey area, with the grey scale values shown in scale 504. As will be appreciated from FIG. 5, the tilt-angle test data shows a higher resistivity core (areas 500 and 502) surrounded by a more conductive ring.

It will be appreciated that the above description is only illustrative and that numerous modifications and alternatives are possible.

Patents and patent applications and other publications disclosed herein, including those cited in the Background of the Invention, are hereby incorporated by reference. Other embodiments of the invention are possible. Although the description above contains many specificities, these should not be construed as limiting the scope of the invention, but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A method for identifying a possible porphyry copper deposit, comprising:
flying an airborne sensor over a survey area measuring natural electromagnetic fields in the survey area; and
determining, in dependence on the measured natural electromagnetic fields, if one or more sub-areas in the survey area have a resistivity pattern that corresponds to a predetermined resistivity signature for a porphyry copper deposit, the predetermined resistivity signature including a higher resistivity inner region at least partially surrounded by a lower resistivity outer region.

2. The method of claim 1 wherein the higher resistivity inner region has a resistivity that is substantially between one to two orders of magnitude higher than the resistivity of the lower resistivity outer region.

3. The method of claim 2 wherein the inner region has an area of between 2 km² to 8 km².

4. The method of claim 3 wherein the inner region and outer region together have an area of between 10 km² to 30 km².

5. The method of claim 2 wherein the outer region substantially surrounds the inner region.

6. The method of claim 1 wherein determining, in dependence on the measured natural electromagnetic fields, if one or more sub-areas in the survey area have a resistivity pattern that corresponds to a predetermined resistivity signature includes calculating tilt angle information for the natural electromagnetic fields in the survey area in dependence on the measured natural electromagnetic fields, the tilt angle information being representative of resistivity characteristics of the survey area.

7. The method of claim 6 comprising measuring attitude changes of the airborne sensor as it flies over the survey area, wherein calculating the tilt angle information is done in dependence on the measured attitude changes to mitigate against noise caused by movement of the airborne sensor.

8. The method of claim 1 comprising conducting a physical on-ground survey of any sub-area in the survey area that has been determined to have a resistivity pattern that corresponds to the predetermined resistivity signature for a porphyry copper deposit.

9. A method for identifying a possible porphyry copper deposit, comprising:
conducting an airborne audio frequency magnetic (“AFMAG”) geophysical survey of a survey area measuring low frequency natural electromagnetic fields in the survey area;
calculating a plurality of tilt angles of the electromagnetic waves of the low frequency natural electromagnetic fields; and
determining in dependence on the calculated tilt angles if one or more sub-areas in the survey area have a resistivity pattern that corresponds to a predetermined resistivity signature for a porphyry copper deposit, the predetermined resistivity signature including a higher resistivity inner region at least partially surrounded by a lower resistivity outer region.

10. The method of claim 9 wherein the higher resistivity inner region has a resistivity that is substantially between one to two orders of magnitude higher than the resistivity of the lower resistivity outer region.

11. The method of claim 10 wherein the inner region has an area of between 2 km² to 8 km².

12. The method of claim 11 wherein the inner region and outer region together have an area of between 10 km² to 30 km².

13. The method of claim 10 wherein the outer region substantially surrounds the inner region.

14. The method of claim 9 wherein determining if one or more sub-areas in the survey area have a resistivity pattern that corresponds to a predetermined resistivity signature for a porphyry copper deposit comprises comparing the calculated tilt angles from different regions of the survey area to identify the one or more sub-areas.
